(19) United States
(12) Patent Application Publication
(10) Pub. No.: US 2009/0308533 A1
(43) Pub. Date: Dec. 17, 2009

(54) FAST-CURING CHEMICAL FIXING SYSTEM AND USE THEREOF

(76) Inventors: Jürgen Grün, Botzingen (DE); Paul Steurer, Teningen (DE); Martin Vogel, Glottertal (DE); Regina Kolesko, Emmendingen (DE)

Correspondence Address: MICHAEL J. STRIKER, 103 EAST NECK ROAD, HUNTINGTON, NY, 11743, US

(21) Appl. No.: 12/306,557

(22) PCT Filed: Jun. 27, 2007
(86) PCT No.: PCT/EP07/05671

§ 371 Date: Dec. 24, 2008

(30) Foreign Application Priority Data
Jun. 29, 2006 (DE) 102006030044.0

(51) Int. Cl. B32B 37/00; C08L 33/26; C08L 33/08; C08L 25/04

(52) U.S. Cl. 156/293; 524/556; 524/555; 524/559; 524/577

(57) ABSTRACT

Rapidly functional chemical fixing systems for anchoring elements, which fixing systems comprise a radically curing olefinic reactive resin formulation, a hardener and optionally additives, wherein the reactive resin formulation is composed of one or more curing olefinic reactive resins, one or more aminic accelerators, one or more non-phenolic (anaerobic) inhibitors and no or one or more phenolic inhibitors, and as the hardener there is provided a hardener with at least one peroxide as the initiator, wherein as the aminic accelerator(s) the reactive resin formulation comprises at least one highly active aminic accelerator in an amount of at least 1.5% by weight, based on the mass of the reactive resin formulation, the mass ratio of the accelerator to phenolic initiator is >5, and the reactive resin formulation comprises as non-phenolic inhibitor(s) up to 5% by weight of at least one non-phenolic inhibitor which has hardly any effect on the curing time, and in the hardener at least 1% of peroxide is provided. The very rapidly curing chemical fixing systems are especially suitable for fixing anchoring elements in the construction industry; these anchoring elements may become fixed a short time after the introduction of the chemical fixing system.

The invention relates to rapidly functional chemical fixing systems, the use thereof, and further embodiments of the invention mentioned further below.

In the construction industry and the fixings sector generally, a series of chemical fixing systems based on resins with radically curing olefinic compounds are known, in particular for fixing anchoring elements, such as screws or bolts, in holes in substrates, such as masonry. There are, for example, corresponding two-component resins or corresponding kits, for example, in the form of multi-chamber cartridges or casings, which hold components (such as monomers and hardeners) separately; these components are mixed with one another (for example, as a result of the small sealed containers being crushed or by static mixers) only at the moment of or shortly before the introduction of anchoring elements into holes, and the anchoring elements can then be introduced into the holes and consequently fixed.

Known chemical fixing systems on this basis have the disadvantage that they require a temperature-dependent and usually fairly long curing time and cannot therefore be put under load immediately. As a general rule, at room temperature the curing time amounts to 30 to 45 minutes or more, which means that it is impossible to introduce the anchoring elements and put them under load at a time closely linked to the introduction of the corresponding resin and synthetic mortar.

Conversely, when using expansible or undercut fixing plugs, a rapid fixing is possible, but in this case the availability of matching fixing plugs and bolt sizes and correspondingly uniform holes or complicated fixing plug constructions to compensate for non-uniform holes are always required. In addition, a fixing free from expansion pressure is not possible here.

The invention therefore addresses the problem of finding a chemical fixing system, which makes possible a short hardening time without the said and further disadvantages of the previous systems, and enables a chemical fixing that can be put under load virtually immediately to be achieved.

In accordance with the invention, this is achieved by a very strongly accelerated system using reactive olefins, in particular (meth)acrylic acid esters, and by the use of inhibitors having an extremely small influence on the gel time and curing time, combined with an especially active aminic accelerator and a minimum of peroxide.

By means of the systems according to the invention, curing times of fewer than 5 minutes at temperatures above −5 (=minus five)° C. can be achieved, with an open time ranging from 5 to 180 sec, for example, 30-120 sec, at 23° C. and a shelf-life of, for example, more than 3 months, preferably 6 months or more. The open time (or gel time) is determined as follows: mortar and hardener are brought to the test temperature (for example, 21° C.), mixed in the desired ratio of components and the time from the start of stirring to a clear increase in viscosity is measured. The gel time or open time is therefore the time in which the compound has a viscosity that is sufficiently low to allow processing (time after mixing, from which the chemical fixing system according to the invention no longer flows freely and/or exhibits partially cured sub-areas).

One embodiment according to the invention relates therefore to a chemical fixing system, which comprises a radically curing (which also includes “curable”), olefinic reactive resin formulation (hereafter called “reactive resin formulation”), a hardener and no or further additives, wherein the reactive resin formulation is composed of one or more radically curing olefinic reactive resins, one or more aminic accelerators, one or more non-phenolic (anaerobic) inhibitors and no or preferably one or more phenolic inhibitors, and as hardener there is provided a hardener having at least one peroxide as the initiator, characterised in that the reactive resin formulation comprises (as the aminic accelerator) at least one highly active aminic accelerator in an amount of at least 1.5, preferably at least 2% by weight, based on the mass of the reactive resin formulation, the mass ratio of accelerator to phenolic inhibitor therein is >5, preferably 10 or greater, (which also implies that in the absence of phenolic inhibitor this ratio is “infinite”), and the reactive resin formulation comprises (as non-phenolic inhibitor(s)) up to 5% by weight, preferably 0.0001 to 5% by weight, based on the mass of the reactive resin formulation, of at least one non-phenolic (anaerobic) inhibitor, which has hardly any effect on the curing time, and in the hardener at least 1% of peroxide, preferably 1.5 to 10%, based on the mass of the reactive resin formulation, are provided (i.e. the at least 1% of peroxide is in addition to the combined 100% of components of the reactive resin formulation).

For the purposes of the present disclosure, the expressions used above and hereafter preferably have in each case the meanings mentioned below, unless otherwise specified, wherein more general expressions may be replaced independently of one another, i.e. alone or severally or in all cases, by more specific definitions, which will lead to possible preferred embodiments of the invention:

“Comprising”, “comprise”, “including” or “include” each mean that in addition to the mentioned constituents yet other constituents may be contained, whereas “consists of” “composed of” and “contain(ing)” means that the constituents mentioned in connection therewith are listed definitively. If a constituent is “provided”, this means that the corresponding system has (includes) this constituent.

A chemical fixing system according to the invention shall be understood to mean primarily the combination of a single-component, or preferably a multi-component, resin, (synthetic mortar, curing composition) based on a radically curing olefinic reactive resin formulation or on components for this formulation, and a hardener (hardener component), wherein other additives also, such as in particular fillers, may be a constituent of the complete chemical fixing system.

Radically curing olefinic reactive resins shall be understood to mean primarily those which include or in particular consist of organic compounds with unsaturated (olefinic) groups as the radically curing (which includes “curable (e.g. before addition of hardener”)) components, in particular those which comprise curable esters with unsaturated carboxylic acid groups, such as preferably vinyl ester resins, for example, in particular acrylate or acrylamide monomers, such as acrylic acid and/or methacrylic acid (these acids or their mixture hereafter being referred to as (meth)acrylic acid, the corresponding esters as (meth)acrylates) or preferably the esters or amides thereof, in particular mono-, di-, or triacrylates or methacrylates (including hydroxypropyl (meth)acrylate, hydroxyethyl (meth)acrylate, ethylene glycol di(meth)acrylate, butanediol di(meth)acrylate or (preferably in each case ethoxylated) bisphenol A, bisphenol F or novolak di(meth)acrylate), epoxy acrylates (in the form in particular of reaction products of di- or polyepoxides, e.g. bisphenol A, bisphenol F or novolak di- and/or novolak polyglycidyl ethers, with olefinic carboxylic acids, for example, C₂-C₇ alkene carboxylic acids, such as in particular (meth)acrylic acid), urethane and/or urea acrylates, and/or unsaturated polyester resins with unsaturated carboxylic acid components, or the like; in particular mono-, di- or triacrylates or methacrylates (especially di(meth)acrylates of ethoxylated bisphenol A, bisphenol F or novolak) and/or epoxy acrylates; or a mixture of two or more of these curable olefinic organic components (organic compounds); wherein alternatively or preferably additionally also other curable olefinic compounds, for example, styrenes, such as styrene, α-methyl styrene, vinyl toluene and/or divinyl benzene can be provided as the radically curing olefinic reactive resin or as one of its constituents. Especially preferred are epoxy acrylates and/or mono-, di- or triacrylates or methacrylates, in particular as defined more specifically above, or mixtures of two or more of these components.

The radically curable olefinic reactive resin (or the total quantity of its components) is present, for example, in a weight proportion of from 5 to 98.5%, such as for instance from 10 to 98.5%, for example, 10 to 89.5%, based on the mass of the reactive resin formulation.

Aminic accelerators that come into consideration are those having a sufficiently high activity. Examples of preferred aminic accelerators are in particular those which have an activity that is greater than that of dimethyl aniline or diethyl aniline, such as in particular (preferably tertiary, in particular hydroxyalkylamino group-substituted) aromatic amines selected from the group comprising N,N-bis(hydroxy C₁-C₇-alkyl) anilines, toluidines or xylidines, in particular N,N-bis(hydroxymethyl or hydroxyethyl) toluidines or xylidines, such as N,N-bis(hydroxymethyl or hydroxyethyl)-p-toluidine, N,N-bis(hydroxyethyl) xylidine and quite particularly corresponding industrial products, which substantially contain N-unsubstituted, N-mono-, N,N-bis-, N,N,N-tris- and/or N,N,N,N-tetrakis(hydroxy-C₁-C₇-alkyl, especially hydroxyethyl)-substituted anilines, p-toluidines or xylidines, for example, in statistical distribution, such as industrial “ethoxylated p-toluidine”. One or more such accelerators are possible. The accelerators preferably have a content (concentration), based on the mass of the reactive resin formulation, of from 1.5 to 10, in particular from 2 to 5% by weight.

Phenolic inhibitors (which are often provided as an already admixed constituent of commercial radically curing reactive resins, but may also be absent) that come into consideration are hydroquinones, such as hydroquinone, mono-, di- or trimethyl hydroquinone, phenols, such as 4,4′-bis(2,6-di-tert-butylphenol), 1,3,5-trimethyl-2,4,6-tris(3,5-di-tert-butyl-4-hydroxybenzyl)benzene, butyl pyrocatechols, such as 3,5-di-tert-butyl-1,2-benzenediol, or in particular 4-methoxyphenol, or mixtures of two or more thereof. Based on the reactive resin formulation, these are preferably present in a proportion of up to 1% by weight, in particular between 0.0001 and 0.5% by weight, for example, between 0.01 and 0.1% by weight. In this connection, the quantity is adjusted so that the weight ratio of accelerator to phenolic inhibitor is >5, preferably 10, more preferably 15 or more, in particular 20 or more (for example, 15 to 70 or, in the case of absence, “infinite”). Preferably, however, phenolic inhibitors are provided, i.e. they are not absent from the reactive resin formulation.

Non-phenolic inhibitors or anaerobic (i.e., in contrast to the phenolic inhibitors, active even without oxygen) inhibitors (which in particular have hardly any effect on the curing times) that come into consideration are preferably phenothiazines, such as phenothiazine, or organic nitroxyl radicals. Organic nitroxyl radicals that may be added are, for example, those as described in DE 199 56 509, which is incorporated herein by reference in particular as regards the compounds mentioned therein, in particular 1-oxyl -2,2,6,6-tetramethyl piperidine-4-ol (“4-OH-TEMPO”). The weight proportion of the non-phenolic inhibitors, based on the reactive resin formulation, is preferably in the range from 1 ppm to 2%, preferably in the range from 10 ppm to 1%. This component is especially useful and usually essential, as otherwise the desired shelf-life (preferably more than 3 months, in particular 6 months or more, for example, more than two years) cannot be achieved. The UV stability and in particular the shelf-life can thus be considerably increased.

The combination of the phenolic and non-phenolic inhibitors here permits a synergistic effect, as also shown by the adjustment of a setting for the gel time of the reactive resin formulation that is substantially free from drift. A reactive resin formulation as such, as mentioned for the chemical fixing systems mentioned above or below or in the claims, is also the subject matter of the present invention.

The hardener contains at least one peroxide as the actual initiator. The term “hardener” in this connection means preferably above and hereafter pure initiators or stabilised initiators with or without the addition of fillers and/or solvents, in other words, the complete hardener component. The hardener can be incorporated as a separate component and/or (in particular in protected form, i.e. for example, in micro-encapsulated form) also in the reactive resin formulation (as a hardenable component, i.e. one that cures by radical polymerisation after mixing with the hardener). For stabilisation, customary additives, such as gypsum, chalk, pyrogenic silica, phthalates, chlorinated paraffin or similar, can be added. In addition, yet further fillers and/or (in particular to form a paste or emulsion) solvents, in particular water, can be added.

Based on the hardener component, the proportion of the initiator in one possible preferred embodiment of the invention is from 1 to 90% by weight, in particular 10 to 60% by weight.

In the case of the radical polymerisation, as the initiators for hardening of the reactive resin formulations according to the invention, use is made of radical-forming peroxides, such as organic peroxides, such as diacyl peroxides, for example, diacetyl peroxide, dibenzoyl or bis(4-chlorobenzoyl) peroxide, ketone peroxides, such as methyl ethyl ketone peroxide or cyclohexanone peroxide, or alkyl peresters, such as tert-butyl perbenzoate, inorganic peroxides, such as persulphates or perborates, and also mixtures thereof.

The proportion of hardener in a chemical fixing system according to the invention, based on the mass of the related reactive resin formulation, is here preferably in a range from 1.2 to 50% by weight, the proportion of peroxide, likewise based on the mass of the related reactive resin formulation (100%), being (additionally) 1 or more % by weight, preferably 1.5 to 10% by weight.

Further additives which may be present in a chemical fixing system according to the invention are in particular fillers, or further additives, such as plasticisers, non-reactive diluents, flexibilisers, stabilisers, curing catalysts, rheology aids, thixotropic agents, wetting agents, colouring additives, such as dyes or especially pigments, for example, for staining the components different colours for improved monitoring of their mixing, or the like, or mixtures of two or more thereof. Such further additives can be added preferably collectively, based on the total mass of the chemical fixing system, in total weight proportions of from 0 to 90%, for example, from 0 to 40% by weight, except in the case of fillers.

As fillers there may be used customary fillers, in particular cements, chalks, sand, quartz sand, quartz powder or the like, which can be added as a powder, in granular form or in the form of moulded bodies, or others, as named for example in WO 02/079341 and WO 02/079293 (which in this regard are incorporated herein by reference), or mixtures thereof. The fillers may be present in one or, in the case of multi-component kits, several components of a multi-component kit according to the invention, for example, in one or both components of a corresponding two-component kit; the proportion of fillers is, for example, preferably from 0 to 90% by weight, for example, from 10 to 90% by weight, based on the total weight of the chemical fixing system according to the invention (and here, casing material crushed when inserting anchoring elements (e.g. splintered glass or splintered plastics), for example, fragments of cartridge, can also be, and preferably is, included as filler).

The fixing systems according to the invention can be provided and also used in the form of single-component systems (when for example, the hardener is protected, for example, encapsulated) or preferably in the form of multi-component systems (multi-component kit).

A multi-component kit shall be understood to mean in particular a two-component or multi-component kit (preferably a two-component kit having the components reactive resin formulation (component a), which may additionally contain yet further additives, as described below, in particular fillers, and hardener (component b)), wherein further additives can be provided in one or both components, preferably a two or more multi-chamber device, which contains the components a) and b) capable of reacting with one another, and optionally further separate components, in such a manner that during storage they are unable to react with each other, preferably in such a manner that before use they do not come into contact with each other, but which, for fastening at the desired place, for example, directly in front of or in a hole, enables the components a) and b) and optionally further components to be mixed and, if applicable, introduced in such a manner that the hardening reaction is able to take place there. Cartridges, for example, of plastics material, ceramics or in particular glass are very suitable (and are especially preferred), in which the components are arranged separately from one another by limiting walls that are destructible (for example, when an anchoring element is driven into a recess such as a drill hole) or by integrated, separate, destructible containers, for example, in the form of cartridges, such as small sealed containers, nested into one another; bottles; plastics-material and foil pouches having two or more compartments, or containers such as buckets or tubs having several compartments, or sets (e.g. packages) of two or more such containers, wherein two or more components of the particular curable composition, in particular two components (a) and (b) as defined above and below, are each present, separated spatially from one another in the form of a kit or set, in which cases the content, after mixing or during mixing, is introduced to the application site (in particular by means of application instruments such as spatulas, brushes, tubes, guns or a static mixer) into a recess (hole), such as a drill hole, to fix anchoring elements such as anchor rods, bolts, screws or the like; and also multi-component or in particular two-component cartridges (which are likewise especially preferred), the chambers of which, for storage prior to use, contain the several or preferably two components (in particular (a) and (b)) of the fixing system according to the invention with compositions mentioned above and hereafter, wherein preferably also a static mixer is part of the corresponding kit. In cases where foil pouches and multi-component cartridges are used, an emptying device can also form part of the multi-component kit, but this may preferably also be independent of the kit (for example, for multiple use or for the benefit of independent exchangeability).

The use of a chemical fixing system according to the invention (in particular, as a special embodiment of the invention, also the use of a reactive resin formulation as described above and hereafter together with an amount of hardener as described above or hereafter) at the desired usage site is effected by mixing associated components, in particular of the reactive resin formulation (wherein the component containing the reactive resin formulation can also comprise further additives, such as in particular fillers), with a hardener, as defined above, at the desired usage site, in particular close to or directly in front of a hole or (for example, in particular when using static mixers or when crushing corresponding cartridges) within a hole, for example, a drill hole. The mixing can be done outside the hole, for example, in a vessel, for example, a bowl, or preferably in a static mixer on a multi-chamber, in particular two- or furthermore three-chamber cartridge, or within the same, for example, when using multi-component cartridges, in particular three- or preferably two-component cartridges. A synthetic mortar having the above-described advantageous properties is obtained.

Fixing shall be understood to mean fixing by means of anchoring devices of metal (for example, undercut anchors, threaded rods, screws, drill anchors, bolts) or furthermore a different material, such as plastics or wood, in solid substrates, in particular, as far as they are part of artificially constructed structures, primarily masonry, ceilings, walls, floors, panels, pillars or the like (for example, of concrete, natural stone, masonry comprising solid bricks or perforated bricks, furthermore plastics material or timber), in particular in holes, such as drill holes. By means of these anchoring devices it is then possible to fix, for example, railings, covering elements, such as panels, facades or other construction elements.

The introduction and mixing (use) is effected in the case of cartridges in the form of multi-chamber systems, the use of which is especially preferred, preferably jointly with the anchoring devices, in particular one of those described in the preceding paragraph, and when using separate containers or particularly extrusion guns with cartridges, in which the components are mixed in a static mixer, in particular directly prior to introduction of the anchoring device. The introduction of the anchoring device(s) is effected preferably a very short time, preferably 5 minutes or less, after mixing the components of the chemical fixing system. For explanatory purposes: as the components are mixed at or introduced into the desired points at which anchoring devices are to be fixed, in particular holes, such as drill holes, several reactions commence essentially in parallel and/or only with a slight delay, in particular the chain polymerisation. The final curing takes place in situ.

From the reactive systems, the gel time at room temperature can be determined by curing after initiation with the particular hardener provided, as explained above, or above and in the examples.

The fact that the anchoring element can be put under load after 5 or fewer minutes, for example, in particular after 1 to 3 minutes (especially at room temperature) means, for example, that parts to be fixed to the anchoring element, for example, panels, railings or similar, can be secured and the anchoring elements put under load without changes in position occurring.

The invention relates in particular to the embodiments of the invention mentioned in the claims and preferably the subsidiary claims, these embodiments being incorporated herein by reference. Very preferred embodiments are described in the examples.

The load at rupture and/or the bond stress, the gel time (as defined above) and the time up to adequate curing for anchoring of fixing elements can be determined generally as described in the examples. One can specify either the failure load=load at rupture with the constraints of the trial (drill hole depth, anchor rod diameter, in particular in each case as mentioned in the examples), or alternatively the bond stress, which is calculated from the quotients of load at rupture and surface area of the bonded part of the anchor rod. Curing time is to be understood as the time after which the load at rupture reaches 80% of the maximum achievable load.

The following examples serve to illustrate the invention, without limiting its scope, percentage details always relating to % by weight.

### EXAMPLE 1

### Fast-Curing Two-Component System and Use Thereof

a) Preparation of a reactive resin formulation for radical curing:

A mixture of 87% of ethoxylated bisphenol-A-dimethacrylate, 10% of hydroxypropyl methacrylate (Bisomer 2 HPMA of the firm Cognis Deutschland GmbH & Co. KG, Dusseldorf, Germany) with 2.8% of ethoxylated toluidine and 0.05% of 4-methoxyphenol and also 0.15% of phenothiazine is prepared, the % details relating to the total weight of the reactive resin formulation (component a)).

b) Preparation of a cartridge:

4 g of component a), 8 g of quartz sand and a small bar of hardener with 0.3 g of dibenzoyl peroxide (50% strength) are introduced into a M12 cartridge. The cartridge is sealed.

c) To fasten an anchoring bolt, the cartridge from 1 b) is inserted into a hole in a wall and the anchoring bolt is caused to vibrate into the hole whilst undergoing rotation and/or impact, the result being that the cartridge is crushed and the hardener and monomers come into contact with one another. The gel time is 40 sec at 21° C.

The shelf-life of the cartridge with filling is more than 2 years. The bond stress is determined by pull-out tests of M12 anchor rods from concrete (C20/C25) with an embedment depth of 95 mm. With a drill hole diameter of 14 mm, the required embedment time (time taken to vibrate the anchor rod to virtually the full embedment depth) is 6.5 seconds, the curing time is only 2 minutes. A load at rupture of 63 kN is measured.

1. Rapidly functional chemical fixing system for anchoring elements, which comprises a radically curing, which includes also “curable”, olefinic reactive resin formulation, a hardener and no or further additives, wherein the reactive resin formulation is composed of one or more curing olefinic reactive resins, one or more aminic accelerators, one or more non-phenolic (anaerobic) inhibitors and no or one or more phenolic inhibitors, and as hardener there is provided a hardener having at least one peroxide as initiator, characterised in that the reactive resin formulation comprises as the aminic accelerator(s) at least one highly active aminic accelerator in an amount of at least 1.5% by weight, based on the mass of the reactive resin formulation, the mass ratio of accelerator to phenolic inhibitor therein is >5, and the reactive resin formulation comprises as non-phenolic inhibitor(s) up to 5% by weight, based on the mass of the reactive resin formulation, of at least one non-phenolic inhibitor, which has hardly any effect on the curing time, and in the hardener at least 1% of peroxide, based on the mass of the reactive resin formulation, is provided.

2. Chemical fixing system according to claim 1, characterised in that at least one phenolic inhibitor is provided in the reactive resin formulation and the mass ratio of accelerator to phenolic inhibitor is >5.

3. Chemical fixing system according to claim 1, characterised in that the reactive resin formulation comprises at least one curing component for radically curing reactive resins, selected from the group comprising vinyl ester resins; acrylate monomers, acrylamide monomers, mono-, di- or triacrylates or mono-, di- or trimethacrylates, epoxy acrylates, urethane acrylates or urea acrylates, unsaturated polyesters with unsaturated carboxylic acid components, and styrenes, or mixtures of two or more such compounds.

4. Chemical fixing system according to claim 1, characterised in that the reactive resin formulation includes 2% or more by weight, based on the mass of the reactive resin formulation, of the aminic accelerator, preferably 2 to 5% by weight, has at least one phenolic inhibitor, the weight ratio of aminic accelerator to phenolic inhibitor is 10 or more, preferably 15 to 70, in particular 20 to 70, and in the hardener at least 1.5% by weight, based on the mass of the reactive resin formulation, preferably at least 2% by weight, in particular 2 to 10% by weight of peroxide are provided.

5. Chemical fixing system according to claim 1, characterised in that, based on the mass of the reactive resin formulation, radically curing olefinic reactive resin or the monomers or monomer mixtures representing it are provided in a proportion by weight of 5 to 98.5%, in particular from 10 to 98.5% by weight.

6. Chemical fixing system according to claim 1, in which as the aminic accelerator in the reactive resin formulation there is provided an aromatic amine selected from the group consisting of N,N-bis(hydroxy C₁-C₇-alkyl) anilines, toluidines or xylidines, in particular N,N-bis(hydroxymethyl or hydroxyethyl) toluidine or xylidine, preferably N,N-bis(hydroxymethyl or hydroxyethyl)-p-toluidine, N,N-bis(hydroxyethyl) xylidine, and of industrial products, which substantially contain in each case N-unsubstituted, N-mono-, N,N-bis-, N,N,N-tris and/or N,N,N,N-tetrakis(hydroxy-C₁-C₇-alkyl, especially hydroxyethyl)-substituted anilines, p-toluidines or xylidines, such as industrial ethoxylated p-toluidine, or mixtures of two or more of these aminic inhibitors.

7. Chemical fixing system according to claim 1, in which as the phenolic inhibitor in the reactive resin formulation there are provided hydroquinone, hydroquinone derivatives, mono-, di- or trimethyl hydroquinone, phenols, in particular 4,4′-bis(2,5-di-tert-butylphenol), 1,3,5-trimethyl-2,4,6-tris(3,5-di-tert-butyl-4-hydroxybenzyl)benzene, butyl pyrocatechols, primarily 3,5-di-tert-butyl-1,2-benzenediol, or 4-methoxyphenol, or a mixture of two or more thereof, wherein, based on the mass of the reactive resin formulation, the amount is adjusted so that the proportion therein is not more than 1% by weight, in particular between 0.0001 and 1% by weight, provided that the weight ratio of aminic accelerator to phenolic inhibitor is >5, preferably 10 or more, in particular 15 or more, for example, up to 70 in each case.

8. Chemical fixing system according to claim 1, characterised in that as non-phenolic inhibitor in the reactive resin formulation there is provided a phenothiazine, in particular phenothiazine itself, or an organic nitroxyl radical, in particular 1-oxyl -2,2,6,6-tetramethylpiperidine-4-ol or a mixture thereof in a proportion by weight, based on the mass of the reactive resin formulation, in the range from 1 ppm to 2%, preferably from 10 ppm to 1%.

9. Chemical fixing system according to claim 1, characterised in that as hardener there is provided a hardener having as the initiator at least one peroxide selected from organic peroxides, in particular diacyl peroxides, preferably diacetyl peroxide, dibenzoyl or bis(4-chlorobenzoyl)peroxide, ketone peroxides, preferably methyl ethyl ketone peroxide or cyclohexanone peroxide, or alkyl peresters, preferably tert-butyl perbenzoate, and also inorganic peroxides, such as persulphates or perborates, wherein at least 2% of peroxide, preferably 2 to 15%, in particular 2 to 10%, in each case based on the mass of the reactive resin formulation, are provided in the hardener.

10. Chemical fixing system according to claim 1, characterised in that in addition to the reactive resin formulation and/or the hardener, it contains one or more additives, in particular fillers and/or further additives, such as plasticisers, non-reactive diluents, flexibilisers, stabilisers, curing catalysts, rheology aids, thixotropic agents, wetting agents, or colouring additives, such as dyes or especially pigments.

11. Chemical fixing system according to claim 1, in the form of a multi-component, in particular two-component system.

12. Chemical fixing system according to claim 11 in the form of a multi-component kit, characterised in that the multi-component kit comprises a cartridge, which contains the reactive resin formulation, optionally with one or more fillers, and the hardener in spatially separated form.

13. Use of a chemical fixing system according to claim 1, for fixing one or more anchoring elements, wherein a reactive resin formulation and a hardener, as mentioned in the said claims, are mixed with one another and subsequently or simultaneously introduced into at least one hole and simultaneously or subsequently at least one anchoring element is inserted into the at least one hole.

14. Use according to claim 13, characterised in that the anchoring element is subjected to load after 5 or fewer minutes, in particular after 1 to 3 minutes.

15. Use according to claim 13, wherein the hole is situated in a substrate that is or will be part of a construction, primarily masonry, ceilings, walls, floors, panels or pillars.

16. Use of a reactive resin formulation according to claim 1 for preparation of a chemical fixing system for fixing purposes in the construction industry, wherein the reactive resin formulation is mixed with a hardener and optionally further additives.
